(19) United States
(12) Patent Application Publication
(10) Pub. No.: US 2007/0010283 A1
(43) Pub. Date: Jan. 11, 2007

(54) Mobile communications terminal for preventing sound leakage during call and method thereof

(75) Inventor: Jae-Eung Kim, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/480,402

(22) Filed: Jul. 5, 2006

(30) Foreign Application Priority Data
Jul. 5, 2005 (KR) 10-2005-0060330

(51) Int. Cl. H04M 1/00

(52) U.S. Cl. 455/550.1

(57) ABSTRACT

A mobile communication terminal including a call sound output unit configured to output a call sound by decoding an analog audio signal, a neutralizing sound output unit configured to output a neutralizing sound by phase-inverting the decoded analog audio signal, a synthesized signal input unit configured to receive a synthesized sound generated by a leaked sound of the call sound being synchronized with the output neutralizing sound, and a controlling unit configured to control a time delay value and a gain value of the neutralizing sound by determining a strength of the received synthesized sound.

The present invention claims priority to Korean Application No. 10-2005-0060330, filed on Jul. 5, 2005, the entire contents of which is hereby incorporated by reference in its entirety.

### BACKGROUND OF THE INVENTION

1. Field of the Invention

The present invention relates to a mobile communication terminal, and more particularly to a mobile communication terminal and method for preventing others from hearing a voice call between parties.

2. Background of the Invention

In general, a third party may overhear what one party is saying to another party during a call (hereinafter referred to as “sound leakage”). Thus, it is difficult for the parties to protect information about his or her personal life. In the related art, a rear portion of the speaker is mechanically well sealed, or the shape of the speaker is formed to be closer to the user's ear. In addition, a gap between front and rear portions of the mobile terminal case is minimized to thereby prevent sound from leaking from the gap. That is, the related art tries to prevent sounds from leaking or being overheard by another party by changing the physical design of the terminal. However, this design has been ineffective in preventing other people from hearing what is being spoken during the call.

### SUMMARY OF THE INVENTION

Accordingly, one object of the present invention is to address the above-noted and other problems.

Another object of the present invention is to provide a mobile communication terminal and method for preventing someone's voice from being leaked during a call.

To achieve these and other advantages and in accordance with the purpose of the present invention, as embodied and broadly described herein, the present invention provides in one aspect a mobile communication terminal including a call sound output unit configured to output a call sound by decoding an analog audio signal, a neutralizing sound output unit configured to output a neutralizing sound by phase-inverting the decoded analog audio signal, a synthesized signal input unit configured to receive a synthesized sound generated by a leaked sound of the call sound being synchronized with the output neutralizing sound, and a controlling unit configured to control a time delay value and a gain value of the neutralizing sound by determining a strength of the received synthesized sound.

In another aspect, the present invention provides a mobile communication method, which includes outputting a call sound by decoding an analog audio signal, outputting a neutralizing sound by phase-inverting the decoded analog audio signal, receiving a synthesized sound generated by a leaked sound of the call sound being synthesized with the output neutralizing sound, and controlling a time delay value and a gain value of the neutralizing sound by determining a strength of the received synthesized sound.

In yet another aspect, the present invention provides a mobile communication method, which includes receiving a call from another party, outputting the received call to an intended party via a first speaker, and outputting a neutralizing sound via a second speaker to neutralize the received voice call so an unintended party can not hear the received voice call.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawinqs:

FIG. 1 is a block diagram illustrating a mobile communication terminal for preventing sound leakage during a call in accordance with the present invention; and

FIG. 2 is a flowchart illustrating a method for preventing sound leakage during a call in accordance with the present invention.

### DETAILED DESCRIPTION OF THE INVENTION

Description will now be given in detail of the present invention, with reference to the accompanying drawings.

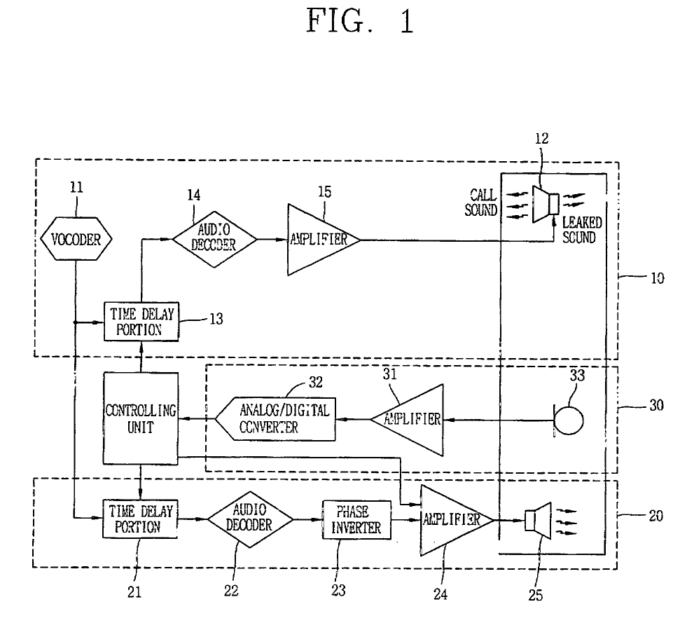

Turning first to FIG. 1, which is a block diagram of a mobile communication terminal for preventing sound leakage during a call in accordance with the present invention. As shown, the mobile terminal includes a call sound output unit 10 for decoding an analog audio signal and outputting the decoded signal, a neutralizing sound output unit 20 for outputting a neutralizing sound by phase-inverting the decoded analog audio signal, a synthesized sound input unit 30 for receiving a synthesized sound in which a leaked sound of the call sound is synthesized with the output neutralizing sound, and a controlling unit 40 for controlling a strength of the neutralizing sound and time delay portions by determining a strength of the synthesized sound.

In addition, as shown, the call sound output unit 10 includes a vocoder 11 for generating an analog audio signal according to characteristic parameters of a sound source and a resonance system, a time delay portion 13 for outputting the generated analog audio signal with a delay for a certain amount of time, an audio decoder 14 for decoding the output analog audio signal with the delay, an amplifier 15 for amplifying the decoded analog audio signal, and a call sound speaker 12 for outputting the amplified analog audio signal to the user.

In addition, the neutralizing sound output unit 20 includes a time delay portion 21 for time-delaying the analog audio signal, an audio decoder 22 for decoding and outputting the time-delayed analog audio signal, a phase inverter 23 for phase-inverting a phase of the output analog audio signal into a reverse phase of the call sound phase, an amplifier 24 for amplifying the phase-inverted analog audio signal, and a neutralizing sound speaker 25 for outputting the amplified analog audio signal as a neutralizing sound which cancels out the leaked call sound.

In more detail, the time delay portion 21 delays an audio signal for a certain amount of time and outputs the delayed audio signal to the audio decoder 22. The audio decoder 22 then decodes the delayed audio signal to output an analog audio signal. Also, the phase inverter 23 receives the decoded audio signal and then phase-inverts the phase of the decoded audio signal into a reverse phase of the call sound phase, which is then output to the amplifier 24. The amplifier 24 amplifies the phase-inverted audio signal, and the speaker 25 outputs the amplified audio signal as a neutralizing sound which is contrary to the leaked call sound. In addition, the phase inverter 23 may be implemented as a single-stage transistor amplifier.

Further, the neutralizing sound speaker 25 is arranged in a same direction as an output direction of the leaked call sound, so as to increase a synthesized degree between the leaked sound and the neutralizing sound. Also, the leaked call sound of the speaker 12 is synthesized with the neutralizing sound of the speaker 25, and the synthesized sound is received by the synthesized sound input unit 30. Here, a strength of the synthesized sound depends on a phase difference and a strength difference between the leaked sound and the neutralizing sound.

As shown in FIG. 1, the synthesized sound input unit 30 includes a monitoring microphone 33 for receiving the synthesized sound from the speakers 12 and 25, an amplifier 31 for amplifying the received synthesized sound to have a certain level, and an analog/digital converter 32 for digital-converting the amplified synthesized sound. The monitoring microphone 33 monitors a strength of the synthesized sound, and is arranged or positioned to facilitate the monitoring of the synthesized sound.

In more detail, the monitoring microphone 33 receives the synthesized sound and converts the signal into an electric signal. The amplifier 31 amplifies the electric signal and the analog/digital converter 32 digital-converts the amplified electric signal to thereafter output it to the controlling unit 40. Then, the controlling unit 40 determines a strength level of the digital-converted electric signal and a change in the strength level based upon time to calculate a time delay value and a gain value of the neutralizing sound, thereby controlling the time delay of the time delay portions 13 and 21 and the gain of the amplifier 24, respectively.

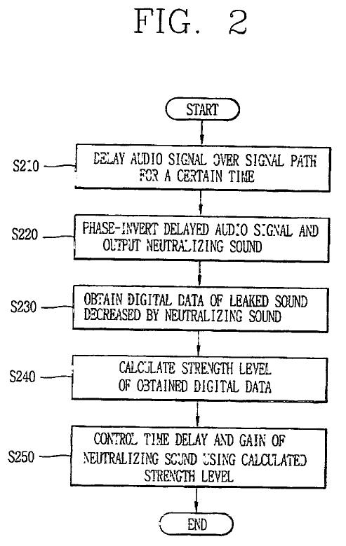

Turning next to FIG. 2, which is a flowchart of a method for preventing sound leakage during a call in accordance with the present invention. As illustrated in FIG. 2, the method includes outputting audio signals over a call sound signal path and a neutralizing sound signal path with delay for a certain amount of time through a time delay portion (S210), and outputting a neutralizing sound by phase-inverting the delayed audio signal to have a reverse phase of a call sound phase through a phase inverter (S220). The method also includes receiving in a monitoring microphone a synthesized sound generated by a leaked sound output from the call sound being synthesized with the neutralizing sound and then digital-converting the synthesized sound through an analog/digital converter to obtain digital data (S230), receiving a strength level of the digital data obtained by the digital-conversion in a controlling unit and determining a change in the strength level based upon time (S240), and controlling a time delay and a gain of the neutralizing sound according to the determination (S250).

Now for a more detailed explanation, the following description relates a party of a mobile terminal communicating with another party. FIG. 1 will also be referred to in this description. While parties are communicating, the vocoder 11 of the call sound output unit 10 generates audio signals of a call channel according to characteristic parameters of the voice source and a resonance system, and then outputs the generated audio signals through a call sound signal path and a neutralizing sound signal path. The audio signal output through the call sound signal path is delayed for a certain amount of time through the time delay portion 13, decoded by the audio decoder 14, amplified by the amplifier 15, and output through the call sound speaker 12. Thus, the calling party can hear the other party.

In addition, the audio signal output through the neutralizing sound signal path is delayed for a certain amount of time through the time delay portion 21, decoded by the audio decoder 22, phase-inverted by the phase-inverter 23 to have a reverse phase of the call sound phase, and amplified by the amplifier 24. The amplified phase-inverted audio signal is then output by the neutralizing sound speaker 25. Here, the audio signal output through the neutralizing sound speaker 25 is a neutralizing sound for removing the leaked sound.

In addition, the time delay portion 21 compensates for a time delay to minimize a decrease of a synthesis effect between the neutralizing sound and the leaked sound due to a time difference between the call sound signal path and the neutralizing sound signal path to fully increase the synthesis effect. Further, in a state that the neutralizing sound and the leaked sound have been output, the leaked sound and the neutralizing sound are synthesized with each other and are received by the monitoring microphone 33.

Here, the strength of the synthesized sound may be changed according to a phase difference and a strength difference between the leaked sound and the neutralizing sound. In addition, the monitoring microphone 33 monitors the strength of the synthesized sound by being arranged or positioned to facilitate the monitoring of the synthesized sound. When the monitoring microphone 33 receives the synthesized sound, the amplifier 31 amplifies the received sounds signal and the analog/digital converter 32 digital-converts the synthesized sound signal.

Based on a strength level of the digital-converted synthesized sound, the controlling unit 40 determines a change in the strength level according to time, and calculates a time delay value and a gain value of the neutralizing sound. The controlling unit 40 then uses the calculated time delay value and gain value to respectively control the time delay portion 21 and the amplifier 24 and also the time delay portion 13 to maintain the strength of the synthesized sound so as to have the lowest level.

As described above, in the mobile terminal and method for preventing the sound leakage during the call (i.e., to prevent others close to the user from overhearing the call), the synthesized sound generated by synthesizing the call sound and the neutralizing sound is monitored and the strength and the time delay of the neutralizing sound are controlled, so as to minimize the sound leakage.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A mobile communication terminal, comprising:
a call sound output unit configured to output a call sound by decoding an analog audio signal;
a neutralizing sound output unit configured to output a neutralizing sound by phase-inverting the decoded analog audio signal;
a synthesized signal input unit configured to receive a synthesized sound generated by a leaked sound of the call sound being synchronized with the output neutralizing sound; and
a controlling unit configured to control a time delay value and a gain value of the neutralizing sound by determining a strength of the received synthesized sound.

2. The terminal of claim 1, wherein the neutralizing sound output unit comprises:
a time delay portion configured to output the analog audio signal with a delay for a certain amount of time;
a phase inverter configured to phase-invert the analog audio signal to have a reverse phase of a phase of the call sound;
an amplifier configured to amplify the phase-inverted analog audio signal to have a certain level set by the controlling unit; and
a neutralizing sound speaker configured to output the amplified analog audio signal in a same direction as an output direction of the leaked sound.

3. The terminal of claim 1, wherein the synthesized sound input unit comprises:
a monitoring microphone configured to receive the synthesized sound generated by the neutralizing sound being synthesized with the leaked sound;
an amplifier configured to amplify the received synthesized sound to have a certain level; and
an analog/digital converter configured to digitally-convert the amplified synthesized sound.

4. The terminal of claim 2, wherein the controlling unit calculates a strength difference between the leaked sound and the neutralizing sound, calculates a gain value of the neutralizing sound corresponding to the calculated value, and outputs the gain value to the amplifier of the neutralizing sound output unit.

5. The terminal of claim 1, wherein the controlling unit calculates a strength difference between the leaked sound and the neutralizing sound, calculates a gain value of the neutralizing sound corresponding to the calculated value, and outputs the calculated value to time delay portions in the call sound output unit and the neutralizing sound output unit.

6. The terminal of claim 2, wherein the neutralizing sound speaker is arranged in the same direction as the output direction of the leaked sound.

7. The terminal of claim 3, wherein the monitoring microphone is arranged in a direction such that the synthesized sound is received to monitor a degree of the strength of the synthesized sound.

8. A mobile communication method, comprising:
outputting a call sound by decoding an analog audio signal;
outputting a neutralizing sound by phase-inverting the decoded analog audio signal;
receiving a synthesized sound generated by a leaked sound of the call sound being synthesized with the output neutralizing sound; and
controlling a time delay value and a gain value of the neutralizing sound by determining a strength of the received synthesized sound.

9. The method of claim 8, wherein outputting the neutralizing sound comprises:
outputting the analog audio signal with a delay for a certain amount of time;
phase-inverting the output analog audio signal to have a reverse phase of a phase of the call sound;
amplifying the phase-inverted analog audio signal to have a certain level set based on the controlled gain value; and
outputting the amplified analog audio signal in a same direction as an output direction of the leaked sound.

10. The method of claim 8, wherein outputting the synthesized sound comprises:
receiving the synthesized sound generated by the neutralizing sound being synthesized with the leaked sound;
amplifying the received synthesized sound to have a certain level; and
digitally-converting the amplified synthesized sound.

11. The method of claim 8, wherein controlling the time delay value and the gain value of the neutralizing sound further comprises:
calculating a strength difference between the leaked sound and the neutralizing sound;
calculating a gain value of the neutralizing sound corresponding to the calculated value; and
amplifying the neutralizing sound using the gain value.

12. The method of claim 8, wherein controlling the time delay value and the gain value of the neutralizing sound further comprises:
calculating a strength difference between the leaked sound and the neutralizing sound;
calculating a gain value of the neutralizing sound corresponding to the calculated value; and
time-delaying the call sound and the neutralizing sound using the calculated gain value.

13. The method of claim 8, wherein outputting the neutralizing sound comprises arranging a speaker in a same direction as an output direction of the leaked sound.

14. The method of claim 10, wherein receiving the synthesized signal comprises arranging a monitoring microphone in a direction such that the synthesized sound is received to monitor a degree of the strength of the synthesized sound.

15. A mobile communication method, comprising:
receiving a call from another party;
outputting the received call to an intended party via a first speaker; and
outputting a neutralizing sound via a second speaker to neutralize the received voice call so an unintended party can not hear the received voice call.

16. The method of claim 15, wherein outputting the neutralizing sound comprises:
phase-inverting the received call;
receiving a synthesized sound corresponding to leaked portion of the call being synchronized with the neutralizing sound; and
controlling a time delay value and a gain value of the neutralizing sound by determining a strength of the synthesized sound.

17. The method of claim 16, wherein controlling the time delay value and the gain value of the neutralizing sound further comprises:
calculating a strength difference between the leaked sound and the neutralizing sound;
calculating a gain value of the neutralizing sound corresponding to the calculated value; and
amplifying the neutralizing sound using the gain value.

18. The method of claim 16, wherein controlling the time delay value and the gain value of the neutralizing sound further comprises:
calculating a strength difference between the leaked sound and the neutralizing sound;
calculating a gain value of the neutralizing sound corresponding to the calculated value; and
time-delaying the call sound and the neutralizing sound using the calculated gain value.

19. The method of claim 16, wherein outputting the neutralizing sound comprises arranging a speaker in a same direction as an output direction of the leaked portion of the call.

20. The method of claim 16, wherein receiving the synthesized signal comprises arranging a monitoring microphone in a direction such that the synthesized sound is received to monitor a degree of the strength of the synthesized sound.
